(19) United States
(12) Patent Application Publication
(10) Pub. No.: US 2016/0259321 A1
(43) Pub. Date: Sep. 8, 2016

(54) Method For Monitoring Industrial Systems

(71) Applicant: GROWTH FINANCE AG, Zug (CH)

(72) Inventor: Waldemar BRUNNMEIER, Bietigheim-Bissingen (DE)

(21) Appl. No.: 15/031,607

(22) PCT Filed: Oct. 16, 2014
(86) PCT No.: PCT/EP2014/072171

§ 371 Date: Apr. 22, 2016

(30) Foreign Application Priority Data
Oct. 25, 2013 (DE) 10 2013 111 819.4
Jan. 2, 2014 (DE) 10 2014 100 001.3

(51) Int. Cl. G05B 19/4063; G05B 19/4065

(52) U.S. Cl. CPC G05B 19/4063; G05B 19/4065; G05B 2219/35529; G05B 2219/50206

(57) ABSTRACT

The invention relates to a method for monitoring industrial systems, in particular machine tools, robots or similar, by means of sensors which determine at least one state of the industrial system, convert into signals and transfer corresponding signals in to an electronic evaluation device. In addition to the actual operational process of the industrial system, an analysis programme should be requested and performed, said analysis programme capturing and processing the signals in the electronic evaluation device.

The invention relates to a method for monitoring industrial systems, in particular machine tools, robots or the like, by means of sensors which determine at least one state of the industrial system, convert it into signals and forward corresponding signals to evaluation electronics.

### PRIOR ART

In many industrial sectors, there are systems which have to be monitored. These include, in particular, machine tools, such as turning machines, machining centers, grinding machines, special machines, but also transfer lines, machine gantries, robots and other handling systems, for example loading gantries. This is only a small selection of the systems to be monitored. The present invention relates to all industrial systems which perform any activities.

In these industrial systems, monitoring work needs to be carried out so that the function of the systems is ensured. In this case, the monitoring must relate to long-term changes, for example wear and tear, but also to short-term changes, for example collisions, overloading, imbalance or the like. Machine components which definitely have to be monitored are those which carry out movements. These include, in particular, units which are active on the corresponding machining axes such as carriages, spindles or else their drive shafts, bearings etc.

U.S. Pat. No. 6,138,056, for example, discloses a system and a method for maintaining and repairing a CNC machine, in which travel and transit time data are determined for the purpose of monitoring the machine axis in order to determine the maintenance and repair times of the machine.

EP-A 0 321 108 discloses a monitoring system for monitoring tools, workpieces or machining processes in cutting machine tools in a manner accompanying the process. In this case, states such as tool breakage, tool break-out, tool wear and tear, tool-to-workpiece contact, rattling or machine collisions are detected and the machine drive is stopped as quickly as possible in order to avoid consequential damage.

EP-A 0 762 248 discloses a method which is used to carry out a post-process check on the basis of measurement data from at least one vibration sensor in order to subsequently characterize defective states in machine tool components.

### OBJECT

The object of the present invention is to improve the monitoring of the above-mentioned industrial systems and to accelerate fault detection, in particular.

### Achievement of the Object

The fact that an analysis program which receives and processes the signals in the evaluation electronics is retrieved and executed outside the actual operating process of the industrial system results in the object being achieved.

The essential feature of the present invention is that a machine state analysis (condition monitoring) takes place outside a machining process at certain intervals of time. For example, the system can be configured in such a manner that the machine tool calls up a special maintenance program and starts different axis movements, in particular without actual machining, with different numbers of revolutions of the spindle once a week or once a day. The physical results, for example by virtue of vibration measurement, of this maintenance program are measured using the monitoring system and are stored for an analysis.

The sensor is preferably a three-axis sensor, but this is only one example if the diagnosis and analysis relate, in particular, to the axes of the industrial system. Its signals are forwarded to an electronic evaluation unit containing special algorithms for state detection. This evaluation unit then preferably also has a communication interface to the machine if this is necessary, with the result that the machine control can be influenced.

Not only are machine-related problems relating to spindles, guide rails, linear roller bearings etc. detected in this manner but also drive problems, lubrication problems etc. However, the vibration is monitored, in particular. The vibrations are analyzed and assessed using different algorithms. The evaluation is carried out according to typical vibration patterns, that is to say using long-standing empirical values from the machine diagnosis.

A fingerprint of the machine is created, in particular at the start of the diagnosis according to the invention. That is to say, all determined values for the machines form an overall picture. At regular intervals, this fingerprint of the machine is compared with the current states and is analyzed and the fingerprint is possibly also adapted (learning process).

In the preferred exemplary embodiment, the method according to the invention is also coupled to a system for ongoing monitoring of the industrial system during its use. That is to say, regular tool monitoring, process monitoring, consisting of hardware electronics, specific software, sensors and possibly a visualization PC, takes place, on the one hand, and condition monitoring using the new system takes place, on the other hand.

For example, collision monitoring more likely takes place with the process monitoring and this collision monitoring is then analyzed using the condition monitoring. However, both monitoring processes preferably also undertake parts of the other. For example, the new method can undertake both collision monitoring and the above-described out-of-process tasks. For the collision monitoring in particular, this means that the response to the detection of a possible collision is accelerated to one millisecond. A similar situation also applies to the detection of and response to a vibration overload.

The invention also includes a corresponding apparatus which consists substantially of a sensor, in particular an acceleration sensor, an evaluation unit and preferably an interface to the machine control.

1. A method for monitoring industrial systems, in particular machine tools, robots or the like, by means of sensors which determine at least one state of the industrial system, convert it into signals and forward corresponding signals to evaluation electronics,
wherein
an analysis program which receives and processes the signals in the evaluation electronics is retrieved and executed outside the actual operating process of the industrial system.

2. The method as claimed in claim 1, wherein the industrial system is controlled using the results of an analysis by the analysis program.

3. The method as claimed in claim 1, wherein axes or axis movements of the industrial system are monitored.

4. The method as claimed in claim 1, wherein at least one acceleration sensor is used for monitoring.

5. The method as claimed in claim 1, wherein vibration monitoring of the industrial system is carried out.

6. The method as claimed in claim 1, wherein collision monitoring of the industrial system is carried out.

7. The method as claimed in claim 1, wherein the signals are analyzed and assessed by means of algorithms.

8. The method as claimed in claim 1, wherein a fingerprint (desired values) of the industrial system is created at least once, but preferably at intervals of time, and is compared with the current signals in each case.

9. The method as claimed in claim 1, wherein the industrial system also has process monitoring.
